(19) United States
(12) Patent Application Publication
(10) Pub. No.: US 2024/0412115 A1
(43) Pub. Date: Dec. 12, 2024

(54) METHOD, APPARATUS, DEVICE AND MEDIUM FOR VERIFYING OUTPUT DATA OF PROCESSING MODEL

(71) Applicant: Beijing Youzhuju Network Technology Co., Ltd., Beijing (CN)

(72) Inventors: Yukun MA, Vancouver (CA); Yingtong BU, Beijing (CN)

(21) Appl. No.: 18/814,332

(22) Filed: Aug. 23, 2024

(30) Foreign Application Priority Data
Aug. 24, 2023 (CN) 202311075471.4

(51) Int. Cl. G06N 20/00

(52) U.S. Cl. CPC G06N 20/00

(57) ABSTRACT

A method, apparatus, device and medium for verifying output data of a processing model are provided. In the method, in response to receiving input data for the processing model, output data corresponding to the input data is determined from the processing model. A verification result associated with the input data and the output data is acquired from a verification model corresponding to the processing model, the verification result indicating a matching degree between the output data and the input data. A final result corresponding to the input data is provided based on the verification result and the output data.

### CROSS-REFERENCE TO RELATED APPLICATIONS

The present application claims priority to Chinese Patent Application No. 202311075471.4, filed on Aug. 24, 2023 and entitled “Method, apparatus, device and medium for verifying output data of processing model”, the entirety of which is incorporated herein by reference.

### FIELD

Exemplary implementations of the present disclosure relate generally to machine learning, and in particular, to methods, apparatuses, devices, and computer-readable storage media for verifying output data of processing model.

### BACKGROUND

Machine learning techniques have been widely used to perform a variety of processing tasks. For example, a variety of the processing models may be built to perform a variety of processing tasks. Input data may be sent to the processing model and output result from the processing model may be received. However, due to training data, model structure, and training process and a variety of other reasons, the results of the processing model output may not completely match the input data. At this time, it is desirable to improve the accuracy of the processing model and enable the processing model to provide a final result that better matches the input data.

### SUMMARY

In a first aspect of the present disclosure, there is provided a method for verifying output data of a processing model. In the method, determine the output data corresponding to input data from the processing model in response to receiving the input data for the processing mode. Acquiring a verification result associated with the input data and the output data from a verification model corresponding to the processing model, the verification result indicates the matching degree between the output data and the input data. Providing a final result corresponding to the input data based on the verification result and the output data.

In a second aspect of the present disclosure, there is provided an apparatus for verifying output data of a processing model. The apparatus includes: a determination module, configured to determine the output data corresponding to input data from the processing model in response to receiving input data for the processing model; an acquisition module, configured to acquire a verification result associated with the input data and the output data from a verification model corresponding to the processing model, the verification result indicating the matching degree between the output data and the input data; and a providing module, configured to provide a final result corresponding to the input data based on the verification result and the output data.

In a third aspect of the present disclosure, there is provided an electronic device. The electronic device includes: at least one processing unit; and at least one memory, the at least one memory being coupled to the at least one processing unit and storing instructions for execution by the at least one processing unit, the instructions causing the electronic device to execute a method according to the first aspect of the present disclosure when executed by the at least one processing unit.

In a fourth aspect of the present disclosure, there is provided a computer-readable storage medium having stored thereon computer programs which, when executed by a processor causes the processor to implement the method according to the first aspect of the present disclosure.

It should be understood that what is described in this section is not intended to define key features or important features of the implementations of the disclosure, nor is it intended to limit the scope of the disclosure. Other features of the present disclosure will become readily understood from the following description.

### BRIEF DESCRIPTION OF DRAWINGS

Hereinafter, the above-mentioned and other features, advantages and aspects of the implementations of the present disclosure will become more apparent with reference to the following detailed description when taken in conjunction with the drawings. In the drawings, the same or similar reference numerals represent the same or similar elements, in which:

FIG. 1 shows a block diagram of an application environment of a processing model according to one exemplary implementation of the present disclosure;

FIG. 2 shows a block diagram for verifying output data of a processing model according to some implementations of the present disclosure;

FIG. 3 shows a block diagram for acquiring a verification model according to some implementations of the present disclosure;

FIG. 4 shows a block diagram for acquiring negative samples according to some implementations of the present disclosure;

FIG. 5 shows a block diagram for acquiring positive samples according to some implementations of the present disclosure;

FIG. 6 shows a block diagram for acquiring positive samples and negative samples according to some implementations of the present disclosure;

FIG. 7 shows a block diagram of a structure of a data portion of a reference sample according to some implementations of the present disclosure;

FIG. 8 shows a block diagram of a page for providing a final result according to some implementations of the present disclosure;

FIG. 9 shows a block diagram of a page for providing a final result according to some implementations of the present disclosure;

FIG. 10 shows a flowchart of a method for verifying output data of a processing model according to some implementations of the present disclosure;

FIG. 11 shows a block diagram of an apparatus for verifying output data of a processing model according to some implementations of the present disclosure; and

FIG. 12 shows a block diagram of a device capable of implementing a plurality of implementations of the present disclosure.

### DETAILED DESCRIPTION

The implementations of the present disclosure will be described in more detail below with reference to the drawings. Although some implementations of the present disclosure are shown in the drawings, it should be understood that the present disclosure may be implemented in various forms and should not be construed as limited to the implementations set forth here, on the contrary, these implementations are provided for a more thorough and complete understanding of the present disclosure. It should be understood that the drawings and implementations of the present disclosure are only used for illustrative purposes, and are not used to limit the protection scope of the present disclosure.

In the description of the implementations of the present disclosure, the term “including” and similar terms should be understood as open inclusion, that is, “including but not limited to”. The term “based on” should be understood as “at least partially based on”. The terms “one implementation” or “the implementations” should be understood as “at least one implementation”. The term “some implementations” should be understood as “at least some implementations”. Other explicit and implicit definitions may be included below. As used herein, the term “model” may represent the association among various data. For example, the above-mentioned association may be acquired based on a variety of technical solutions currently known and/or to be developed in the future.

It may be understood that the data involved in this technical scheme (including but not limited to the data itself, data acquisition or use) shall comply with the requirements of respective laws, regulations and relevant provisions.

It may be understood that before using the technical solutions disclosed in various embodiments of this disclosure, users should be informed of the types, scope of use, use scenarios, and the like of personal information involved in this disclosure in an appropriate manner according to relevant laws and regulations, and be authorized by users.

For example, in response to receiving an active request from a user, a prompt message is sent to the user to explicitly prompt the user that the operation requested to be performed will require acquiring and using the user's personal information. Thereby, the user may independently choose whether to provide personal information to electronic devices, applications, servers or storage media and other software or hardware that perform the operation of the technical scheme of the present disclosure according to the prompt information.

As an optional but non-limiting implementation, the approach to sent the prompt information to the user in response to receiving the user's active request, for example, may be the approach of pop-up window, in which the prompt information may be presented by way of characters. In addition, the pop-up window may also carry a selection control for the user to choose “agree” or “disagree” to provide personal information to the electronic device.

It is understandable that the above-mentioned notification and the process of acquiring user authorization are merely illustrative and do not constitute a limitation on the implementations of the present disclosure, other approaches that satisfy relevant laws and regulations may also be applied to the implementations of the present disclosure.

The term “in response to” as used here means a state in which a respective event occurs or a condition is satisfied. It will be understood that the timing of executing the subsequent actions executed in response to the event or condition is not necessarily strongly related to the time when the event occurs or the condition is established. For example, in some cases, the subsequent action may be executed immediately when the event occurs or the condition is established; while in other cases, the subsequent action may be executed after a period of time has passed since the event occurred or the condition was established.

### Example Environment

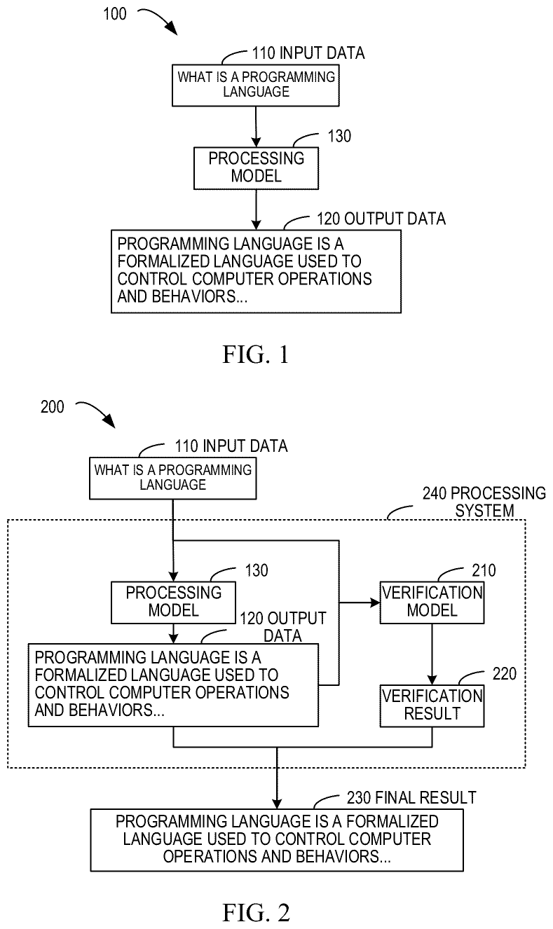

Machine learning techniques have been widely used to perform a variety of processing tasks. An application environment according to one example implementation of the present disclosure is described with reference to FIG. 1, which shows a block diagram 100 of an application environment of a processing model according to one example implementation of the present disclosure. As shown in FIG. 1, a processing model 130 may be pre-built, and the input data 110 may be provided to the processing model 130. For example, under the environment of language processing model, the input data 110 may be “what is a programming language”, and so on. At this time, the processing model 130 may provide the output data 120 that matches the input data 110 for interpreting the meaning of the programming language.

Due to training data, model structure, and training process and a variety of other reasons, the results of the processing model output may not completely match the input data. Specifically, Large Model-generated Hallucination refers to the results that may appear when using large deep learning models (such as Large Language Model (LLM for abbreviation), image generation models, etc.) to generate new content or answer questions, which are inconsistent with the actual situation or have no actual basis. This phenomenon usually stems from data bias during model training, inaccurate training data, or lack of logical constraints and other factors.

A variety of reasons may cause hallucination in large models, and the main reasons are as follows. (1) Data bias: If the training data is biased or repeatedly repeats existing wrong and misleading information, the model may learn these wrong cognitions, thereby creating hallucination when generating content. (2) Over-fitting: The model may over-learn the noise and information in the training data, and produce fictitious or inaccurate results when generating the content. These results may seem real, but they are actually caused by the over-fitting of the model to the data. (3) Insufficient training data: the model requires a large amount of data during training to obtain more comprehensive knowledge. If the amount of training data is insufficient or the quality is low, the model may not fully understand the information about an entity or concept, thereby creating hallucination when generating content. (4) Lack of logical constraints: Since deep learning models are often based on statistics and probability, they may lack consistent logic when generating content. This may cause the model to produce inconsistent or illogical hallucination in its output.

Aiming at the problem of hallucination generated by large models, solutions have been proposed from the data level and the model level. For example, at the data level, the following approaches may be used to alleviate hallucination. (1) Data cleaning: utilize more detailed and clear labeling to generate the training data of the large model, so that these data may reduce prejudice, errors and misleading content as much as possible. Although this method may reduce the occurrence of large model hallucinations from the source, the manpower investment required is very huge. (2) Vector database: Retrieve domain or encyclopedia knowledge through vector database, and input the retrieved content into the model, so that the answers generated by the model have a source and are traceable. However, the cost of maintaining and researching and developing the vector database is huge, which requires more research and development manpower. (3) Integration into the knowledge base: Each vertical domain knowledge may have a knowledge base within that domain, and similarity retrieves may be performed between the user's input data and the model's output data and the content in the knowledge base, thereby identifying which content involves model hallucination and which content is within the scope of the domain knowledge base. This method also relies on the knowledge base of vertical domain, and the building of this knowledge base also requires research and development costs.

For another example, at the model/strategy level, the following approaches may be adopted. (1) Based on RLHF (Reinforce Learning From Human Feedback): this reinforcement learning method based on human feedback may align with human knowledge and adjust parameters at the model level. However, it is difficult and tedious to implement the RLHF framework itself. In addition, process-based supervision mainly solves the problem that in the model reasoning task, supervising each reasoning step can reduce the generation of model hallucination, and this method is superior to the method of simply supervising the generated results. However, in question-and-answer where there is no or not requiring reasoning process, the advantages of this method are difficult to demonstrate. (2) Data retrieval: This method makes the user input into a vector, and then retrieves the training set or related data in the vertical domain, which also requires additional engineering support related to data and vector retrieval. (3) Cross-verification of model generation and search engine: This method is to send the question to the big model and search engine at the same time after the user inputs it, and then verifies the returned content with each other to determine whether the model generation is a hallucination. This also increases the complexity of the process and resource overhead.

Although the above-mentioned approaches may alleviate the problem of hallucination, the data-level approaches require additional operations on the training data or require additional knowledge bases, and the model and strategy-level approaches require additional training steps or execution processes. This greatly increases the difficulty and complexity of data processing and improves the time consumption. At this time, it is desirable to improve the accuracy of the processing model and enable the processing model to provide a final result that better matches the input data.

### Overview Of The Verification Process

In order to at least partially solve the shortcomings in the prior art, according to one exemplary implementation of the present disclosure, a method for verifying the output data of a processing model is proposed. An overview according to one exemplary implementation of the present disclosure is described with reference to FIG. 2, which shows a block diagram 200 for verifying output data of a processing model according to some implementations of the present disclosure. As shown in FIG. 2, a verification model 210 may be added downstream of the processing model 130, and the processing system 240 at this time may include the processing model 130 and the verification model 210. The verification model 210 may be utilized to determine whether the output data 120 from the processing model 130 matches the input data 110 (i.e., whether the output data 120 is correct), and in turn provides a final result 230 based on the output data 130 and the verification result 220.

Specifically, a user may build input data 110 and submit the input data 110 to the processing system 240. Upon receiving the input data 110 for the processing model, the processing system 240 may acquire the output data 120 corresponding to the input data 110 from the processing model 130. Further, the input data 110 and the output data 120 may be inputted to the downstream verification model 210, so as to acquire the verification result 220 associated with the input data 110 and the output data 120 from the verification model 210 corresponding to the processing model 130. It should be understood that the verification model 210 here may be a pre-constructed model for describing the association between input data and output data. For example, the verification result 220 may represent the matching degree between the output data and the input data, that is, whether the output data is the correct answer to the input data.

According to one example implementation of the present disclosure, the verification result 220 may indicate the matching degree between the output data and the input data. For example, the verification model 210 may be a binary classification model that describes correct or wrong, that is, the verification result 220 may be represented by 1 (hallucination) and 0 (non-hallucination). Alternatively and/or additionally, the verification model 210 may also be represented by a real number in the range of [0,1], and a larger numerical value may represent that there is a greater probability that the output data is a hallucination. Further, the processing system 240 may provide the final result 230 for the input data 110 based on the verification result 220 and the output data 120.

In this way, the verification model 210 may determine whether the output data 120 directly provided by the processing model 130 is correct (i.e., whether it is a hallucination), and in turn generates the final result 230. For example, assuming that the verification result 220 indicates that the matching degree of the output data 120 is high (i.e., non-hallucination), the output data 120 may be directly provided as the final result 230. Assuming that the verification result 220 indicates that the matching degree of the output data 120 is low (i.e., hallucination), the user may be reminded that the output data 120 may not be accurate, and/or reminded to check whether the input data 110 includes a clerical error, and so on. At this time, the processing system 240 as a whole may receive the input data 110 and provide a more accurate final result 230.

Utilizing the exemplary implementation of the present disclosure, the verification system 210 may quickly judge whether the output data 120 is correct, and in turn outputs the respective final result 230 to the user. In this way, the accuracy of the processing system 240 may be improved without introducing an additional knowledge base.

### Detailed Process Of Verification Process

An overview of one example implementation according to the present disclosure has been described with reference to FIG. 2. It should be understood that although FIG. 2 describes the processing model 130 with a language model as an example. Alternatively and/or additionally, the processing model 130 may include a multi-modal processing model. At this time, the input data 110, the output data 120 and the final result 230 may span a plurality of modes, thus a variety of tasks with richer expressions may be handled.

According to one example implementation of the present disclosure, the verification model 210 may be a pre-built model. It should be understood that the processing model 130 may involve a large number of domains, for example, in the case that the processing model 130 is a large language model, the processing model 130 may involve a large number of tasks in a huge domain, for example, query, translation, analysis etc. At this time, the verification model 210 may be obtained for each subdivided vertical domain. In this way, the difficulty of generating verification models for all domains may be reduced, and the accuracy of the processing model 130 in the subdivided vertical domain may be improved.

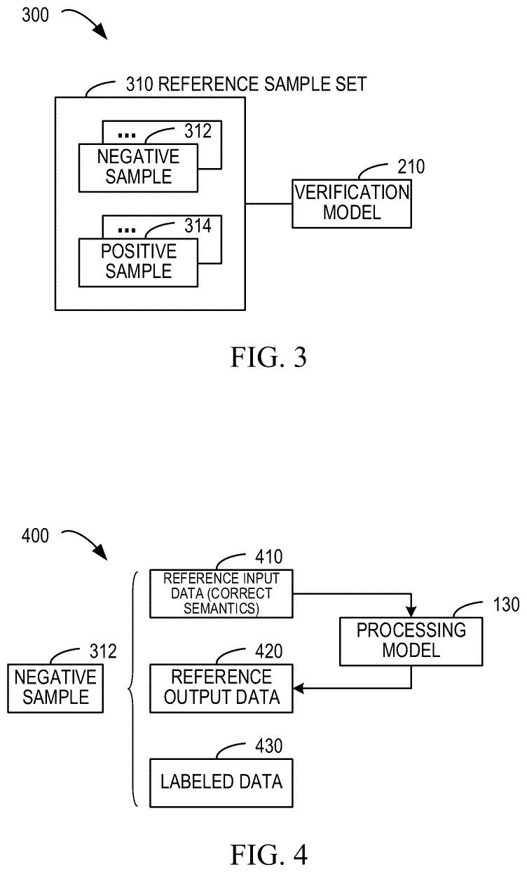

According to one example implementation of the present disclosure, the verification model 210 may be established based on the approaches that have been currently proposed and/or will be developed in the future. Further, the verification model 210 may be updated utilizing the input data 110 and the output data 120. Specifically, a reference sample set for training the verification model 210 may be built. More details about the reference sample set are described with reference to FIG. 3, which shows a block diagram 300 for acquiring a verification model according to some implementations of the present disclosure. As shown in FIG. 3, the reference sample set 310 may include a large number of reference samples, for example, positive samples 314 and negative samples 312.

The data portion of each reference sample may include reference input data and reference output data, and the labeled portion of each sample may represent the matching degree between the output data and the input data (e.g., represented 0 and 1). Further, these samples may be utilized to train the verification model 210 respectively, so that the verification model 210 may describe the matching degree between the output data and the input data, that is, determine whether the output data is a hallucination.

According to one example implementation of the present disclosure, reference input data may be generated. The reference input data may be inputted to the processing model 130, so as to acquire reference output data corresponding to the reference input data from the processing model 130. Further, reference samples for acquiring the verification model may be generated utilizing reference input data, reference output data, and the matching degree between reference output data and reference input data. Hereinafter, the process of generating negative samples is described with reference to FIG. 4, which shows a block diagram 400 for acquiring negative samples according to some implementations of the present disclosure.

As shown in FIG. 4, reference input data 410 with semantic meaning may be acquired. For example, in the case that the processing model 130 is a language model, the text with correct semantics expressed in natural language may be used as a reference input data 410. The reference input data 410 may be inputted to the processing model 130, and the reference output data 420 may be obtained. The labeled data 430 may be determined, for example, the labeled data 430 may be determined based on the manual labeling; or for another example, the labeled data 430 may be automatically determined. It should be understood that since the reference input data 410 has the correct semantic meaning, in the case that the processing model 130 has been relatively fully trained, the reference output data 420 provided by the processing model 130 is the correct answer and there is no hallucination. At this time, the labeled data 430 may be set to “0” to represent non-hallucination.

It should be understood that in the process of generating negative samples, no additional knowledge base is required, and no additional manual labeling process is required. In this way, negative samples may be generated in a simple and effective manner. At this time, in the case that the processing model 130 has been fully trained, the processing model 130 may be reused to generate negative samples, thus reducing the complexity of generating training samples and various resource overhead. Further, the reference input data 410, the reference output data 420, and the labeled data 430 may be utilized to generate negative samples for training the verification model 210. Table 1 below shows examples of generated negative samples.

TABLE 1
Examples of negative samples

| Serial | Reference | | |
|---|---|---|---|
| number | input data | Reference output data | Labeling |
| 1 | What is a | Programming language is a formal language used to | 0 |
| | programming | control computer operations and behaviors. It is an | |
| | language | approach of writing computer programs that | |
| | | implement algorithms or accomplish specific | |
| | | calculations or tasks. | |
| | | . . . | |
| 2 | What is | Programming is a process of communicating | 0 |
| | programming | instructions to a computer in a specific | |
| | | programming language. Through programming, we | |
| | | may make the computer perform various tasks, such | |
| | | as operation, data processing, content creation and, | |
| | | information output, etc. There are many | |
| | | programming languages, including: Python, Java, | |
| | | C++, JavaScript, Ruby, etc. | |
| | | . . . | |
| . . . | . . . | . . . | . . . |

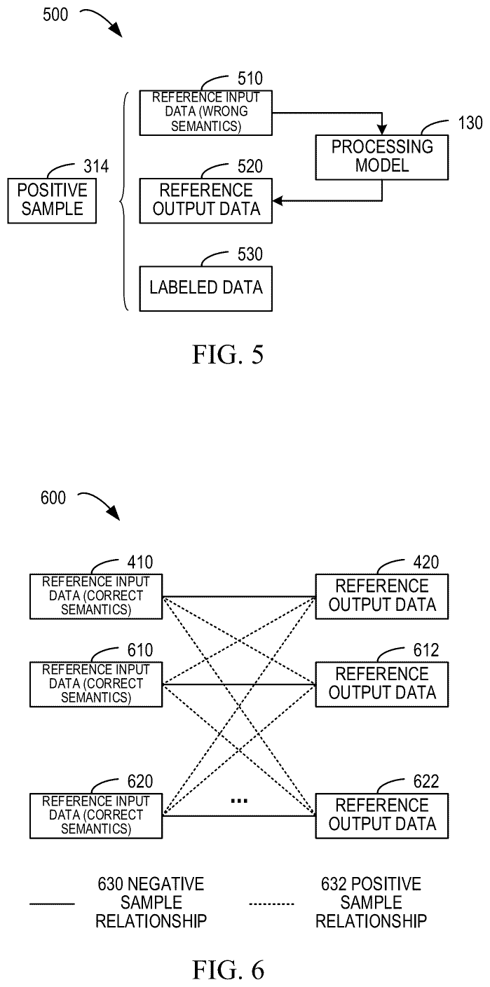

According to one example implementation of the present disclosure, a positive sample for training the verification model 210 may be generated. More details are described with reference to FIG. 5, which shows a block diagram 500 for acquiring negative samples according to some implementations of the present disclosure. As shown in FIG. 5, reference input data 510 without semantic meaning may be acquired. For example, in the case that the processing model 130 is a language model, the text with wrong semantics expressed in natural language may be used as a reference input data 510. The reference input data 510 may be inputted to the processing model 130, and the reference output data 520 may be obtained.

At this time, the labeled data 530 may be determined based on concepts, reasoning, question-and-answer content and other knowledge in the relevant field. For example, the labeled data 530 may be determined based on the manual labeling approaches; the labeled data 530 may be determined based on the comparison with the above-mentioned knowledge; or for another example, the labeled data 530 may be automatically determined. It should be understood that since the reference input data 510 has the wrong semantic meaning, the processing model 130 cannot understand the query content expressed by the reference data 510, and the reference output data 520 provided by the processing model 130 will be the wrong answer, that is, a hallucination. At this time, the labeled data 530 may be set to “1” to represent hallucination. Further, the reference input data 510, the reference output data 520 and the labeled data 530 may be utilized to generate the positive sample 314 for training the verification model 210.

It should be understood that in the process of generating positive samples, no additional knowledge base is required, and no additional manual labeling process is required. In this way, positive samples may be generated in a simple and effective manner. According to one example implementation of the present disclosure, a large number of negative samples may be generated for training the verification model 210 based on the method described above.

According to one example implementation of the present disclosure, the reference input data 410 with semantic meaning may be referred to as true input data, and the reference input data 510 without semantic meaning may be referred to as pseudo input data. The pseudo input data may be generated by modifying the true input data, for example, at least a portion of the true input data may be replaced to create the pseudo input data. For example, the true input data may be “programming language”, which may replace any one or more of the above-mentioned characters, for example, “programming” may be replaced with “progreming” which has a pronunciation and/or glyph, and “programming” may be replaced with “programmer” which has a similar pronunciation, and so on.

Alternatively and/or additionally, the pseudo input data may be generated by splicing, for example, two or more unrelated texts (e.g., “programming language” and “repurchase strategy”) may be spliced, where the spliced texts do not have correct semantic texts. Utilizing the example implementation of the present disclosure, the pseudo input data may be quickly and effectively determined, thus generating positive samples for detecting hallucination. Table 2 below shows examples of generated positive samples.

TABLE 2
Examples of Positive Samples

| Serial | Reference | | |
|---|---|---|---|
| number | input data | Reference output data | Labeling |
| 1 | What is a bias | Bias language (programming language) is a | 1 |
| | language | language form, which contains words that are | |
| | | prejudiced or discriminate against someone or | |
| | | something. This prejudice may be based on gender, | |
| | | race, age, sexual orientation, religion, nationality, | |
| | | socio-economic status and many other factors. | |
| 2 | Bias language | According to your question, I assume that you want | 1 |
| | repurchase | to know how to repurchase or correct the prejudice | |
| | strategy | in the language. Here are some effective strategies: | |
| | | . . . | |
| . . . | . . . | . . . | . . . |

According to one example implementation of the present disclosure, a plurality of true input data with semantic meaning may be respectively acquired, and a plurality of true output data corresponding to the plurality of true input data may be respectively acquired from the processing model. Further, positive samples and/or negative samples may be generated utilizing each input data and output data. More details of generating samples are described with reference to FIG. 6, which shows a block diagram 600 for acquiring positive samples and negative samples according to some implementations of the present disclosure. As shown in FIG. 6, a plurality of reference input data 410, 610, . . . , 620 with correct semantics may be acquired. The above-mentioned reference input data may be respectively inputted to the processing model 130, and a plurality of reference output data 420, 612, . . . , 622 may be respectively received from the processing model 130.

As shown in FIG. 6, a legend 630 shown in a solid line represents a negative sample relationship between two data, and a legend 632 shown in a dotted line represents a positive sample relationship between two data. At this time, the negative samples may include: (reference input data 410, reference output data 420, 0), (reference input data 610, reference output data 612, 0), . . . , (reference input data 620, reference output data 622, 0).

Further, generate a positive sample for a first true input data among the plurality of true input data may utilize the first true input data and a second true output data among the plurality of true output data corresponding to a second true input data other than the first true input data. Alternatively and/or additionally, a plurality of positive samples may be generated, for example, another positive sample in the reference samples may be generated utilizing the second true input data and the first true output data corresponding to the first true input data among the plurality of true output data. That is, positive samples may be generated utilizing mismatched reference input data and reference output data.

Utilizing the example implementation of the present disclosure, a large number of positive samples may be generated in a combined manner, and in turn improves the efficiency of the training process.

In the example of FIG. 6, positive samples may include: (reference input data 410, reference output data 612, 1), . . . , (reference input data 410, reference output data 622, 1), (reference input data 610, reference output data 420, 1), . . . , (reference input data 610, reference output data 622, 1), (reference input data 620, reference output data 420, 1), . . . , (reference input data 620, reference output data 612, 1). In the case that there are only two true input data, the order of the two true input data may be exchanged (or the order of the output data corresponding to the two true input data may be exchanged), and in turn generates respective positive samples. Utilizing the example implementation of the present disclosure, the process of generating positive samples may be simplified, and in turn improves the speed of generating positive samples. For example, the order of the reference input data in Table 1 may be exchanged, and a positive sample as shown in Table 3 below may be generated.

TABLE 3
Examples of Positive Samples

| Serial | Reference | | |
|---|---|---|---|
| number | input data | Reference output data | Labeling |
| 1 | What is | Programming language (programming language) is | 1 |
| | programming | a formal language used to control computer | |
| | | operations and behaviors. It is an approach of | |
| | | writing computer programs that implement | |
| | | algorithms or accomplish specific calculations or | |
| | | tasks. | |
| | | . . . | |
| 2 | What is a | Programming is a process of communicating | 1 |
| | programming | instructions to a computer in a specific | |
| | language | programming language. Through programming, we | |
| | | may make the computer perform various tasks, such | |
| | | as operation, data processing, content creation and, | |
| | | information output, etc. There are many | |
| | | programming languages, including: Python, Java, | |
| | | C++, JavaScript, Ruby, etc. | |
| | | . . . | |
| . . . | . . . | . . . | . . . |

It should be understood that the above process is only schematic, and alternatively and/or additionally, the verification model 210 may be a model for detecting correct answers. At this time, the labeled data 430 in FIG. 4 may be set to “1” to represent the correct answer, and the generated reference sample may be used as a positive sample. Further, the labeled data 530 as shown in FIG. 5 may be set to “0” to represent a wrong answer, and the generated reference sample may be used as a negative sample. At this time, the generated positive samples and negative samples may be utilized to train the verification model 210 so that the trained verification model 210 outputs “1” when a correct answer is detected, and outputs “0” when a wrong answer is detected.

The processes for generating positive samples and negative samples have been described above, and a large number of samples may be generated based on the above-mentioned processes, and in turn trains the verification model 210. In the case that the verification model 210 has been obtained, the trained verification model 210 may be utilized to judge whether the output of the processing model 130 is a hallucination. For example, input data 110 and output data 120 may be submitted to the verification model 210, and verification result 220 may be received from the verification model 210.

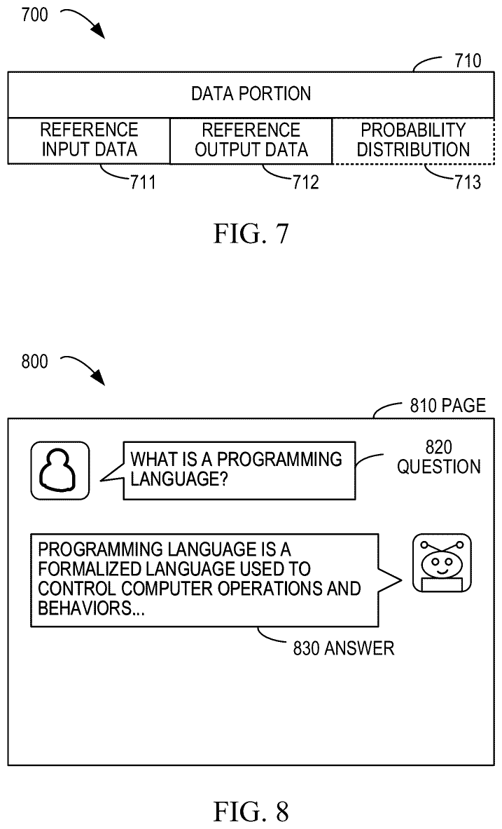

It should be understood that although the above only shows the case that only reference input data and reference output data are included in the data portion of the reference sample. Alternatively and/or additionally, the data portion may include more features. For example, the probability distribution of each element in the reference output data may be acquired from the processing model 130. More details about the data portion of the reference sample are described with reference to FIG. 7, which shows a block diagram 700 of the structure of the data portion of the reference sample according to some implementations of the present disclosure.

As shown in FIG. 7, the data portion 710 may include reference input data 711, reference output data 712, and probability distribution 713. Here, the probability distribution 713 may be the intermediate data of the processing model 130, for example, it may represent each element in the reference output data (e.g., the probability of a basic language unit such as, a character or a word). At this time, the negative samples shown in Table 1 may be rewritten as shown in Table 4. Similarly, a new column “Probability Distribution” may be inserted into the examples of positive samples shown in Tables 2 and 3.

TABLE 4
Examples of negative samples

| Serial | Reference | | | |
|---|---|---|---|---|
| number | input data | Reference output data | Probability distribution | Labeling |
| 1 | What is a | Programming language (programming | [0.2233, 0.4234, 0.154 . . . ] | 0 |
| | programming | language) is a formal language used | | |
| | language | to control computer operations and | | |
| | | behaviors. It is an approach of | | |
| | | writing computer programs that | | |
| | | implement algorithms or | | |
| | | accomplish specific calculations or | | |
| | | tasks. | | |
| | | . . . | | |
| 2 | What is | Programming is a process of | [0.2003, 0.3900, 0.1541 . . . ] | 0 |
| | programming | communicating instructions to a | | |
| | | computer in a specific programming | | |
| | | language. Through programming, we | | |
| | | may make the computer perform | | |
| | | various tasks, such as operation, data | | |
| | | processing, content creation and, | | |
| | | information output, etc. There are | | |
| | | many programming languages, | | |
| | | including: Python, Java, C++, | | |
| | | JavaScript, Ruby, etc. | | |
| | | . . . | | |
| . . . | . . . | . . . | . . . | . . . |

At this time, the verification model 210 may further describe the association among the reference input data, the reference output data, the probability distribution of each element in the reference output data, and the matching degree. Since the probability distribution 713 may describe the expected occurrence probability of each element in the process of generating the reference output data 712 based on the reference input data 711, the format shown in FIG. 7 may more accurately describe the intermediate details of the processing process of the processing model 130, and in turn characterizes the association among the input and the output in a more accurate and effective manner.

When using the verification model 210 involving probability distribution, a large number of samples may be generated based on the above-mentioned process, and in turn trains the verification model 210. In the case that the verification model 210 has been obtained, the trained verification model 210 may be utilized to judge whether the output of the processing model 130 is a hallucination. For example, the input data 110, the output data 120, and the probability distribution of each element in the output data 120 may be submitted to the verification model 210, and the verification result 220 may be received from the verification model 210. In this way, whether the output data 120 is a hallucination may be verified in a more accurate manner. In turn, the respective final result is provided to the user based on the verification result.

According to one example implementation of the present disclosure, if it is determined that the verification result satisfies a predetermined condition, the output data may be directly provided. More details are described with reference to FIG. 8, which shows a block diagram 800 of a page for providing a final result according to some implementations of the present disclosure. As shown in FIG. 8, in page 810, the user may ask the question 820 “What is a programming language?” At this time, in the processing system background, you may input “What is a programming language” to the verification model and the output from the processing model “Programming language . . . ”

In the case that the verification result output by the verification model satisfies predetermined conditions (e.g., in the case that the verification model is a binary classification model, the verification result is “O” (i.e., non-hallucination); or in the case that the verification model outputs a predicted probability, the verification result is less than or equal to a predetermined value (e.g., 0.5 or other numerical values)), the output data from the processing model 130, that is, the answer 830, may be provided directly to the user. In this way, it may be ensured that the answer 830 output to the user is not a hallucination and is a verified correct answer, thus ensuring the accuracy of the final result output by the processing system.

According to one example implementation of the present disclosure, if it is determined that the verification result does not satisfy the predetermined condition, at least any one of the following is provided: output data, an indication of the matching degree between the output data and the input data. For example, assuming that the verification result output by the verification model does not satisfy the predetermined conditions (e.g., in the case that the verification model is a binary classification model, the verification result is “1” (i.e., a hallucination); or in the case that the verification model outputs a predicted probability, the verification result is greater than a predetermined value (e.g., 0.5 or other numerical values)), the user may be prompted that: the correct answer matching the question may not be found; or the user may be prompted that: the answer provided may not be completely accurate. Further, the output data from the processing model may be provided after the prompt statement. In this way, the user may be reminded to pay attention, and in turn prevents the user from making the next judgment based on the possibly incorrect answer.

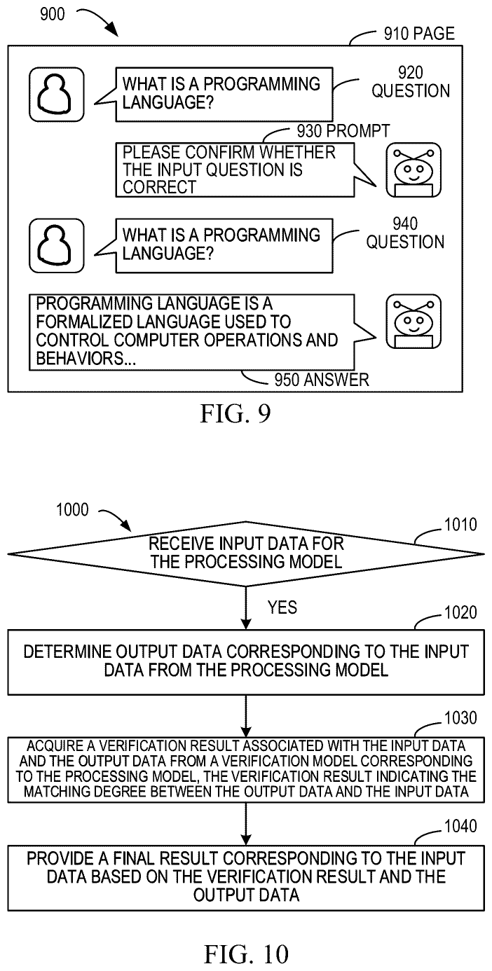

Alternatively and/or additionally, the user may be further prompted to modify the indication of the input data. More details are described with reference to FIG. 9, which shows a block diagram 900 of a page for providing a final result according to some implementations of the present disclosure. As shown in FIG. 9, assume that a user inputs a question 920, in which the term “programming language” is wrongly inputted as “bias language”. At this time, the page 910 may provide a prompt 930 and ask the user whether the question inputted is correct. The user may check and find the clerical error in the question 920, correct the clerical error and input the correct question 940. At this time, the processing model 130 may output output data corresponding to the question 940. In the case that the verification model 210 confirms that the output data is not a hallucination, the page 910 may output an answer 940. In this way, it is convenient to find the errors in the user's questions, and in turn reminds the user to correct the errors and output the correct answers.

According to one example implementation of the present disclosure, if it is determined that the verification result does not satisfy the predetermined condition, it represents that there is a potential problem in the process of processing the input data by the processing model. This problem could be caused by errors in the input data itself, or it could be caused by problems with the model itself and/or the training data. At this time, the technicians of the processing system may be reminded to pay special attention to the input data, and in turn performs respective tests and adjustments. For example, the correct data corresponding to the input data may be acquired to update the processing model. In this way, the hallucination in the processing model may be found quickly and effectively, and in turn eliminates the hallucination.

It should be understood that although the specific implementation of the present disclosure is described above with a Chinese-based natural language model, the process of verifying output data may alternatively and/or additionally be implemented in other language environments. For example, in English, French, German, Japanese and other environments, positive samples and negative samples may be generated based on the approaches described above, and in turn utilizes these samples to train the verification model.

According to one example implementation of the present disclosure, in a multi-modal environment, multi-modal positive samples and negative samples may be built based on the approaches described above. Assuming that the processing model 130 may generate images based on text input, at this time, positive samples and negative samples may be generated based on the above-mentioned method. For example, you may input “draw a cat” to get an image of a cat, and you may replace “cat” with “dog” to get an image of a dog. At this time, (“draw a cat”, cat image, 0) may be utilized as a negative sample, (“draw a dog”, dog image, 0) may be utilized as a negative sample, (“draw a cat”, dog image, 1) may be utilized as a positive sample, and (“draw a dog”, cat image, 1) may be utilized as a positive sample. Further, the above-mentioned samples are utilized to train the verification model.

Utilizing the example implementation of the present disclosure, the verification model 210 downstream of the processing system 130 may quickly judge whether the output data 120 is correct, and in turn outputs the adjusted final result 230 to the user. In this way, the accuracy of the processing system 240 may be improved without introducing an additional knowledge base.

In the process of hallucination identification of large model outputs in a vertical domain, content that does not exist in the vertical domain may be detected, and content that exists but the model outputs wrong answers may be detected. For the first case, the verification model may identify content that does not exist in the domain, and at this time it may be concluded with a high probability whether the content is a hallucination. For the second case, the verification model may determine that there may be a mismatch between the question inputted by the user and the answer output by the model.

Further, when considering the probability distribution of elements in the output data, the processing model itself may also predict the probability value of the next element. Generally speaking, if the processing model is more confident in outputting a certain element, the greater the probability value; on the contrary, the smaller. At this time, the probability value of each element in the output data of the large model may be used as an aid to input the verification model, which may help to improve the accuracy of the detection model. The verification model of vertical domain may involve the following contents: the concept of vertical domain, reasoning, question-and-answer content and other knowledge, for example, hallucination detection cases of input data and output data, and the probability value output by the processing model itself.

In the vertical domain, it is not necessary to perform manual processing for the constructed hallucination question-and-answer pair, but it may be directly used for training. Specifically, the modeling process may be performed based on the following approaches. A large model encoder may be used to extract the vector V1 of the question and the vector V2 of the answer, respectively. V1, V2 and the probability value vector V3 may be spliced and inputted into the classifier. Real hallucination samples may be used as a test set, and the above classifier may be used to test the data set to obtain model performance indicators, and the verification model may be continuously optimized to improve the accuracy of identifying hallucination.

When the verification model identifies the hallucination of processing the model output, the user may be prompted by configuring the standard template: the model is temporarily unavailable to output questions; if no hallucination is detected, the content output by the processing model may be directly returned to the user after passing through other post-processing modules. In various vertical domains, it is possible to reduce the output of hallucinatory information and reduce the misleading of users without relying on external knowledge base or retrieval framework, and in turn improves the practicability of vertical large model.

### Example Process

FIG. 10 shows a flowchart of a method 1000 for verifying output data of a processing model according to some implementations of the present disclosure. At block 1010, it is determined whether input data for the processing model is received. If input data is received, the method 1000 proceeds to block 1020 where output data corresponding to the input data is determined from the processing model. If input data is received, the method 1000 proceeds to block 1020 to determine output data corresponding to the input data from the processing model. At block 1030, acquiring a verification result associated with the input data and the output data from a verification model corresponding to the processing model, the verification result indicates the matching degree between the output data and the input data. At block 1040, providing a final result corresponding to the input data based on the verification result and the output data.

According to one example implementation of the present disclosure, a verification model is acquired by: acquiring reference output data corresponding to reference input data from a processing model; generating a reference sample for acquiring the verification model utilizing the reference input data, reference output data, and the matching degree between the reference output data and the reference input data; and acquiring the verification model based on the reference sample.

According to one example implementation of the present disclosure, the reference input data is true input data with semantic meaning, and the reference sample is a negative sample of the verification model.

According to one example implementation of the present disclosure, the reference input data is pseudo input data without semantic meaning, and the reference sample is a positive sample of the verification model.

According to one example implementation of the present disclosure, the pseudo input data is acquired by: acquiring true input data with semantic meaning; and replacing at least a portion of the true input data to create pseudo input data.

According to one example implementation of the present disclosure, generating a reference sample includes: respectively acquiring a plurality of true input data with semantic meanings; respectively acquiring a plurality of true output data corresponding to the plurality of true input data from a processing model; and generating a positive sample for a first true input data among the plurality of true input data utilizing the first true input data and a second true output data among the plurality of true output data corresponding to a second true input data other than the first true input data.

According to one example implementation of the present disclosure, the method 1000 further includes generating another positive sample in the reference samples utilizing the second true input data and the first true output data corresponding to the first true input data among the plurality of true output data.

According to one example implementation of the present disclosure, the verification model further describes the association among the reference input data, the reference output data, the probability distribution of each element in the reference output data, and the matching degree.

According to one example implementation of the present disclosure, generating the reference sample further includes: generating the reference sample utilizing the probability distribution of each element in the reference output data determined by the processing model.

According to one example implementation of the present disclosure, providing a final result includes: providing output data in response to determining that the verification result satisfies a predetermined condition.

According to one example implementation of the present disclosure, providing a final result includes: providing at least any one of the following in response to determining that the verification result does not satisfy the predetermined condition: output data, an indication of the matching degree between the output data and the input data, and an indication for modifying the input data.

According to one example implementation of the present disclosure, the method 1000 further includes: updating the processing model utilizing the input data and the output data corresponding to the input data in response to determining that the verification result does not satisfy the predetermined condition.

According to one example implementation of the present disclosure, the processing model is a multi-modal processing model, and the verification model corresponds to the domain of input data.

### Example Apparatus and Device

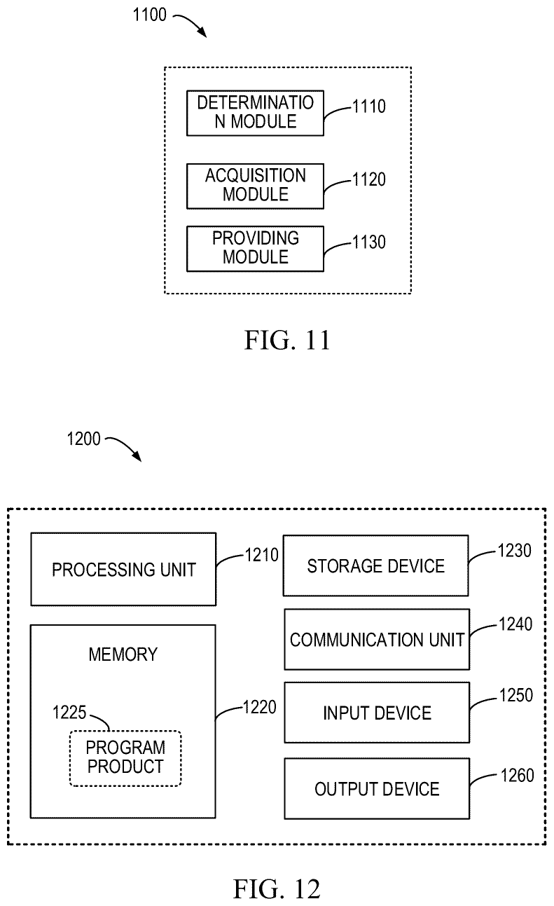

FIG. 11 shows a block diagram of an apparatus 1100 for verifying output data of a processing model according to some implementations of the present disclosure. The apparatus includes: a determination module 1110, configured to determine output data corresponding to the input data from the processing model in response to receiving input data for the processing model; an acquisition module 1120, configured to acquire a verification result associated with the input data and the output data from a verification model corresponding to the processing model, the verification result indicating the matching degree between the output data and the input data; and a providing module 1130, configured to provide a final result corresponding to the input data based on the verification result and the output data.

According to one example implementation of the present disclosure, a verification model is acquired by: a data acquisition module configured to acquire reference output data corresponding to reference input data from a processing model; a generation module configured to generate a reference sample for acquiring the verification model utilizing reference input data, reference output data, and the matching degree between the reference output data and the reference input data; and a model acquisition module configured to acquire the verification model based on the reference sample.

According to one example implementation of the present disclosure, the reference input data is true input data with semantic meaning, and the reference sample is a negative sample of the verification model.

According to one example implementation of the present disclosure, the reference input data is pseudo input data without semantic meaning, and the reference sample is a positive sample of the verification model.

According to one example implementation of the present disclosure, the pseudo input data is acquired by: a first data acquisition module configured to acquire true input data with semantic meaning; and a replacement module configured to replace at least a portion of the true input data to create pseudo input data.

According to one example implementation of the present disclosure, the generation module includes: a second data acquisition module configured to acquire a plurality of true input data with semantic meanings, respectively; a true output data acquisition module configured to respectively acquire a plurality of true output data corresponding to a plurality of true input data from the processing model; and a first positive sample generation module configured to generate a positive sample for a first true input data among the plurality of true input data may utilize the first true input data and a second true output data among the plurality of true output data corresponding to a second true input data other than the first true input data.

According to one example implementation of the present disclosure, the apparatus further includes a second positive sample generation module configured to generate another positive sample in the reference samples utilizing the second true input data and the first true output data corresponding to the first true input data among the plurality of true output data.

According to one example implementation of the present disclosure, the verification model further describes the association among the reference input data, the reference output data, the probability distribution of each element in the reference output data, and the matching degree.

According to one example implementation of the present disclosure, the generating module further includes: a distribution-based generating module configured to generate a reference sample utilizing the probability distribution of each element in the reference output data determined by the processing model.

According to one example implementation of the present disclosure, a providing module includes: a first providing module configured to provide output data in response to determining that a verification result satisfies a predetermined condition.

According to one example implementation of the present disclosure, the providing module includes: the second providing module provides at least any one of the following in response to determining that the verification result does not satisfy the predetermined condition: output data, an indication of the matching degree between the output data and the input data, and an indication for modifying the input data.

According to one example implementation of the present disclosure, the apparatus further includes: an update module configured to update the processing model utilizing the input data and the output data corresponding to the input data in response to determining that the verification result does not satisfy the predetermined condition.

According to one example implementation of the present disclosure, the processing model is a multi-modal processing model, and the verification model corresponds to the domain of input data.

FIG. 12 shows a block diagram of a device 1200 capable of implementing a plurality of implementations of the present disclosure. It should be understood that the computing device 1200 shown in FIG. 12 is merely exemplary and should not constitute any limitation on the function and scope of the implementations described herein. The computing device 1200 shown in FIG. 12 may be used to implement the method described above.

As shown in FIG. 12, the computing device 1200 is in the form of a general-purpose computing device. Components of computing device 1200 may include, but are not limited to, one or more processors or processing units 1210, memory 1220, storage device 1230, one or more communication units 1240, one or more input devices 1250, and one or more output devices 1260. The processing unit 1210 may be an actual or virtual processor and may perform various processes according to programs stored in the memory 1220. In a multiprocessor system, a plurality of processing units executes computer-executable instructions in parallel to improve the parallel processing capability of the computing device 1200.

Computing device 1200 typically includes a plurality of computer storage media. Such media may be any available media accessible by computing device 1200, including but not limited to volatile and nonvolatile media, removable and non-removable media. The memory 1220 may be volatile memory (e.g., register, cache, random access memory (RAM)), nonvolatile memory (e.g., read-only memory (ROM), electrically erasable programmable read-only memory (EEPROM), flash memory) or some combination thereof. Storage device 1230 may be a removable or non-removable medium and may include machine-readable media for example, a flash drive, a disk, or any other medium that may be capable of being used to store information and/or data (e.g., training data for training) and may be accessed within computing device 1200.

The computing device 1200 may further include additional removable/non-removable, volatile/nonvolatile storage media. Although not shown in FIG. 12, a magnetic disk drive for reading or writing from a removable, nonvolatile magnetic disk (e.g., “floppy disk”) and an optical disk drive for reading or writing from a removable, nonvolatile optical disk may be provided. In these cases, each drive may be connected to a bus (not shown) by one or more data media interfaces. The memory 1220 may include a computer program product 1225 having one or more program modules configured to perform various methods or actions of a plurality of implementations of the present disclosure.

The communication unit 1240 enables communication with other computing devices through a communication medium. Additionally, the functions of the components of the computing device 1200 may be implemented in a single computing cluster or a plurality of computing machines, which may communicate through communication connections. Thus, the computing device 1200 may operate in a networked environment using logical connections with one or more other servers, a network personal computer (PC) or another network node.

The input device 1250 may be one or more input devices, for example, a mouse, a keyboard, a trackball, etc. The output device 1260 may be one or more output devices, for example, a display, a speaker, a printer, etc. The computing device 1200 may also communicate with one or more external devices (not shown) through the communication unit 1240 as required, such as storage devices, display devices, etc., with one or more devices that enable users to interact with the computing device 1200, or with any devices that enable the computing device 1200 to communicate with one or more other computing devices (e.g., network cards, modems, etc.). Such communication may be performed via an input/output (I/O) interface (not shown).

According to an exemplary implementation of the present disclosure, there is provided a computer-readable storage medium having stored thereon computer-executable instructions, wherein the computer-executable instructions are executed by a processor to implement the method described above. According to an exemplary implementation of the present disclosure, there is also provided a computer program product, the computer program product is tangibly stored on a non-transitory computer-readable medium includes and computer-executable instructions, and the computer-executable instructions are executed by a processor to implement the method described above. According to an exemplary implementation of the present disclosure, there is provided a computer program product having stored thereon computer programs which, when executed by a processor, the method described above is implemented.

Various aspects of the present disclosure are described herein with reference to flowcharts and/or block diagrams of methods, apparatuses, devices and computer program product implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus, thereby producing a machine such that when these instructions are executed by the processing unit of the computer or other programmable data processing apparatus, a device is generated that implements the functions/actions specified in one or more blocks in the flowchart and/or block diagram. These computer-readable program instructions may also be stored in a computer-readable storage medium, which enables a computer, a programmable data processing apparatus and/or other device to operate in a specific manner, so that the computer-readable medium storing the instructions includes a manufactured product, which includes instructions for implementing various aspects of the functions/actions specified in one or more blocks in the flowchart and/or block diagram.

Computer-readable program instructions may be loaded onto a computer, other programmable data processing apparatus, or other device so that a series of operating steps are performed on the computer, other programmable data processing apparatus, or other device to produce a computer-implemented process, so that the instructions executed on the computer, other programmable data processing apparatus, or other device implement the functions/actions specified in one or more blocks in the flowchart and/or block diagram.

The flowcharts and block diagrams in the drawings show the architectures, functions and operations of possible implementations of systems, methods and computer program product according to a plurality of implementations of the present disclosure. In this regard, each block in the flowchart or block diagram may represent a module, a program segment or a portion of an instruction, and the module, a program segment or a portion of an instruction contains one or more executable instructions for implementing specified logical functions. In some alternative implementations, the functions labeled in the blocks may also occur in a different order than those labeled in the drawings. For example, two consecutive blocks may actually be executed substantially in parallel, and they may sometimes be executed in the reverse order, depending on the functions involved. It should also be noted that each block in the block diagrams and/or flowcharts, and combinations of blocks in the block diagrams and/or flowcharts, may be implemented by a dedicated hardware-based system that performs specified functions or actions, or may be implemented by a combination of dedicated hardware and computer instructions.

Implementations of the present disclosure have been described above, and the above-mentioned descriptions are exemplary, not exhaustive, and are not limited to the disclosed implementations. Many modifications and variations will be apparent to those of ordinary skill in the art without departing from the scope and spirit of the described implementations. The terms used in this document are selected to best explain the principles of each implementation, practical application or improvement of technology in the market, or to enable other ordinary technicians in this technical domain to understand the various implementations disclosed herein.

What is claimed is:

1. A method for verifying output data of a processing model, comprising:
in response to receiving input data for the processing model, determining output data corresponding to the input data from the processing model;
acquiring a verification result associated with the input data and the output data from a verification model corresponding to the processing model, the verification result indicating a matching degree between the output data and the input data; and
providing a final result corresponding to the input data based on the verification result and the output data.

2. The method according to claim 1, wherein the verification model is acquired by:
acquiring reference output data corresponding to reference input data from the processing model;
generating a reference sample for acquiring the verification model utilizing the reference input data, the reference output data and a matching degree between the reference output data and the reference input data; and
acquiring the verification model based on the reference sample.

3. The method according to claim 2, wherein the reference input data is true input data with a semantic meaning, and the reference sample is a negative sample of the verification model.

4. The method according to claim 2, wherein the reference input data is pseudo input data without a semantic meaning, and the reference sample is a positive sample of the verification model.

5. The method according to claim 4, wherein the pseudo input data is acquired by:
acquiring a true input data with a semantic meaning; and
replacing at least a portion of the true input data to create the pseudo input data.

6. The method according to claim 4, wherein generating the reference sample comprises:
acquiring a plurality of true input data with semantic meanings, respectively;
acquiring a plurality of true output data corresponding to the plurality of true input data from the processing model, respectively; and
generating the positive sample for first true input data of the plurality of true input data utilizing the first true input data and second true output data of the plurality of true output data corresponding to second true input data other than the first true input data.

7. The method according to claim 6, further comprising: generating another positive sample in the reference sample utilizing the second true input data and the first true output data corresponding to the first true input data of the plurality of true output data.

8. The method according to claim 2, wherein the verification model further describes an association between the reference input data, the reference output data, a probability distribution of each element in the reference output data and the matching degree.

9. The method according to claim 8, wherein generating the reference sample further comprises: generating the reference sample utilizing the probability distribution of each element in the reference output data determined by the processing model.

10. The method according to claim 1, wherein providing the final result comprises: in response to determining that the verification result satisfies a predetermined condition, providing the output data.

11. The method according to claim 1, wherein providing the final result comprises: in response to determining that the verification result does not satisfy a predetermined condition, providing at least any one of: the output data, an indication of a matching degree between the output data and the input data, or an indication for modifying the input data.

12. The method according to claim 1, further comprising: in response to determining that the verification result does not satisfy a predetermined condition, updating the processing model utilizing the input data and the output data corresponding to the input data.

13. The method according to claim 1, wherein the processing model is a multi-modal processing model, and the verification model corresponds to a domain of the input data.

14. An electronic device including:
at least one processing unit; and
at least one memory coupled to the at least one processing unit and storing instructions for execution by the at least one processing unit, the instructions, when executed by the at least one processing unit, cause the electronic device to perform a method comprising:
in response to receiving input data for a processing model, determining output data corresponding to the input data from the processing model;
acquiring a verification result associated with the input data and the output data from a verification model corresponding to the processing model, the verification result indicating a matching degree between the output data and the input data; and
providing a final result corresponding to the input data based on the verification result and the output data.

15. The electronic device according to claim 14, wherein the verification model is acquired by:
acquiring reference output data corresponding to reference input data from the processing model;
generating a reference sample for acquiring the verification model utilizing the reference input data, the reference output data and a matching degree between the reference output data and the reference input data; and
acquiring the verification model based on the reference sample.

16. The electronic device according to claim 15, wherein the reference input data is true input data with a semantic meaning, and the reference sample is a negative sample of the verification model.

17. The electronic device according to claim 15, wherein the reference input data is pseudo input data without a semantic meaning, and the reference sample is a positive sample of the verification model.

18. The electronic device according to claim 17, wherein the pseudo input data is acquired by:
acquiring a true input data with a semantic meaning; and
replacing at least a portion of the true input data to create the pseudo input data.

19. The electronic device according to claim 17, wherein generating the reference sample comprises:
acquiring a plurality of true input data with semantic meanings, respectively;
acquiring a plurality of true output data corresponding to the plurality of true input data from the processing model, respectively; and
generating the positive sample for first true input data of the plurality of true input data utilizing the first true input data and second true output data of the plurality of true output data corresponding to second true input data other than the first true input data.

20. A non-transitory computer-readable storage medium having computer programs stored thereon, the computer programs, when executed by a processor, causes the processor to implement a method comprising:
in response to receiving input data for a processing model, determining output data corresponding to the input data from the processing model;
acquiring a verification result associated with the input data and the output data from a verification model corresponding to the processing model, the verification result indicating a matching degree between the output data and the input data; and
providing a final result corresponding to the input data based on the verification result and the output data.
